(19) United States
(12) Patent Application Publication
(10) Pub. No.: US 2014/0263892 A1
(43) Pub. Date: Sep. 18, 2014

(54) FIXTURE MOUNTING SYSTEMS FOR COUNTER TOPS

(71) Applicants: Paul R. Metcalfe, Solon, OH (US); Scott E. Urban, University Heights, OH (US)

(72) Inventors: Paul R. Metcalfe, Solon, OH (US); Scott E. Urban, University Heights, OH (US)

(73) Assignee: GOJO Industries, Inc., Akron, OH (US)

(21) Appl. No.: 13/843,514

(22) Filed: Mar. 15, 2013

(51) Int. Cl. F16M 13/02

(52) U.S. Cl. CPC F16M 13/02
USPC 248/205.3; 248/226.11

(57) ABSTRACT

Exemplary embodiments of fixture mounting systems are disclosed herein. An exemplary fixture mounting system includes an upper fixture mount, a lower fixture mount and a plurality of connectors extending between the upper fixture mount and the lower fixture mount. The lower fixture mount has a first portion and a second portion. The first portion and the second portion are connected together by a hinge. The first portion and the second portion may be folded together and inserted through a hole in a countertop and the first and second portion unfold upon passing through the countertop. The plurality of connectors are tightened to secure the upper fixture mount and the lower fixture mount to the counter.

### TECHNICAL FIELD

The present invention relates generally to counter mount devices and fixtures, and more particularly to system for fixture mounting systems.

### BACKGROUND OF THE INVENTION

Fixtures such as faucets, soap dispensers, instant hot water dispensers, water purifying systems and the like are often mounted to counter tops. Mounting such systems to the counter tops is often difficult and requires special tools. In addition, because most of these systems are located behind a sink it is difficult to see and reach into the areas of installation. In addition, many of these installations require special tools to tighten mounting nuts to the fixture. As a result, installation of such devices often requires a person to hire a plumber.

### SUMMARY

Exemplary embodiments of fixture mounting systems are disclosed herein. An exemplary fixture mounting system includes an upper fixture mount, a lower fixture mount and a plurality of connectors extending between the upper fixture mount and the lower fixture mount. The lower fixture mount has a first portion and a second portion. The first portion and the second portion are connected together by a hinge. The first portion and the second portion may be folded together and inserted through a hole in a countertop and the first and second portion unfold upon passing through the countertop. The plurality of connectors are tightened to secure the upper fixture mount and the lower fixture mount to the counter.

Another exemplary fixture mounting system includes an upper fixture mount a lower fixture mount and a plurality of cables extending between the upper fixture mount and the lower fixture mount. A connector tightening mechanism is also provided. The lower fixture mount having a first portion and a second portion and the first portion and the second portion may be folded together and inserted through a hole in a countertop. The first and second portions unfold upon passing through the countertop. The plurality of connectors are tightened to secure the upper fixture mount and the lower fixture mount to the counter.

Another exemplary fixture mounting system includes an upper fixture mount, a lower fixture mount and a plurality of connectors extending between the upper fixture mount and the second fixture mount. The exemplary system also includes a connector tightening system. The lower fixture mount has a first portion and a second portion. The first portion and the second portion may be folded together and inserted through a hole in a countertop and the first and second portion unfold upon passing through the countertop. The plurality of connectors are tightened to secure the upper fixture mount and the lower fixture mount to the counter.

### BRIEF DESCRIPTION OF THE DRAWINGS

These and other features and advantages of the present invention will become better understood with regard to the following description and accompanying drawings in which:

FIG. 1 is a prospective view of an exemplary fixture mounting system mounted to a counter top.

FIG. 2 is a cross-section of the exemplary fixture mounting system of FIG. 1.

FIG. 3 is a side view of the exemplary fixture mounting system of FIG. 1.

FIG. 4 is a prospective view of the exemplary fixture mounting system of FIG. 1.

FIG. 5 is an end view of the lower fixture mount of the fixture mounting system of FIG. 1 folded in half;

FIG. 6 is a prospective view of an above counter fixture mounted to the fixture mounting system of FIG. 1;

FIG. 7 is a prospective view of the exemplary fixture mounting system of FIG. 1 with an above counter fixture mounted to the upper fixture mount and a below counter fixture mounted to the lower fixture mount; and

FIG. 8 is a rear view of the exemplary above counter and below counter mounted fixtures of FIG. 7.

### DETAILED DESCRIPTION

FIGS. 1 through 5 illustrate an exemplary embodiment of a fixture mounting system 100. Fixture mounting system 100 is mounted to a counter top 102. Fixture mounting system 100 includes an upper fixture mount 104 and a lower fixture mount 106. An opening 120 extends through fixture mounting system 100. Opening 120 allows components, fluids, electronics, pipes, tubes, and the like, to extend or travel from below the counter top 102 to above the counter top 102 as known in the art.

Upper fixture mount 104 includes a plurality of connectors 130. Connectors 130 are used to connect an above the counter fixture (not shown) to upper fixture mount 104. In some embodiments, connectors 130 are projections projecting out from upper fixture mount 104. A space below connector 130 allows a ring (not shown) on the above counter fixture (not shown) to snap into the space and secure the above counter fixture to the above counter fixture mount 104. Other types of connectors may be used, such as for example, threaded connection, snap-fit in combination with friction fit, an adhesive connection for permanent installations or the like.

In addition, in some embodiments, upper fixture mount 104 extends higher above the counter than is shown to provide greater support for an above counter fixture. In some embodiments, upper fixture mount 104 includes an annular projection 240 that fits within hole 204 of counter 102 and helps to secure upper fixture mount 104 to the counter top 102 and prevents sideways movement of fixture mounting system 100.

In addition, in some embodiments a gasket 230 is provide between upper fixture mount 104 and counter top 102. In some embodiments, gasket 230 is compressed when the fixture mounting system 100 is secured to counter top 102. The compressed gasket 230 provides an upward force that helps to keep connectors 206 under tension and keep the fixture mounting system 100 securely in place. In some embodiments, an adhesive is used instead of gasket 230. In some embodiments, gasket 230 includes an adhesive layer (not shown) on its surfaces to further secure the fixture mountings system 100 in place. Upper fixture mount 104 may be made of a plastic material, a composite material, a metal material, combinations thereof and the like.

Lower fixture mount 106 has a first portion 106A and a second portion 106B, which are described in more detail with respect to FIGS. 4 and 5. In addition, lower fixture mount 106 includes a plurality of connectors 140, which are used to connect under counter mount fixtures (not shown) to lower fixture mount 106. In some embodiments, connector 140 is an elongated slot on each side of the fixture mount 106. Lower fixture mount 106 includes a sloped surface 142 for aiding in engaging with a lower fixture mounting system such as the one described with respect to FIGS. 7 and 8.

Lower fixture mount 106 has a first portion 106A and a second portion 106B. In some embodiments, first portion 106A and second portion 106B are connected to one another by a hinge 402 (FIGS. 4, 5), which is made out of resilient plastic and biases the first and second positions to an unfolded position. The hinge 402 may be other types of hinges, such as, for example, a pin and socket type hinge, a living hinge or the like. In addition, the hinge 402 may include a biasing member (not shown), such as, for example a spring to bias the lower fixture mount 106 in the unfolded position as illustrated in FIG. 4. The hinge 402 may be made of any resilient material that tends to return to its original state and unfold the first and second portions of the lower fixture mount and is strong enough to keep first portion 106A connected to second portion 106B.

In some embodiments, lower fixture mount 106 is u-shaped (not shown). A u-shaped lower fixture mount may slide over an annular ring (not shown) around, for example, a hot or cold water valve housing, wherein the hot or cold water valve housing is pushed up into the opening in the counter and the u-shaped lower fixture mount connects to the water valve housing under the annular ring and when the fixture mounting system is tightened, the u-shaped lower fixture holds the water valve housing in place. Accordingly, lower fixture mount 106 may have fixtures attached to it, or it may attach to fixtures.

Counter tops 102 often range from 1 to 3 inches thick and have a standard 1 inch hole 204 therethrough. During installation, lower fixture mount 106 is folded in half FIG. 5 illustrates the lower fixture mount 106 folded in half and the view is looking down on the folded lower fixture mount 106 as it would be positioned to slide through a 1 inch diameter hole. When folded in half, lower fixture mount 106 can be pushed through the hole 204 in the counter top 102. Once lower fixture mount 106 has passed through the hole 204, the lower fixture mount 106 unfolds. In its unfolded condition, lower fixture mount 106 cannot pull back up through the hole 204 in counter top 102. Connectors 206 are tightened to secure lower fixture mount 106 and upper fixture mount 104 to the counter top 102.

In addition, the exemplary embodiment of a fixture mounting system 100 includes a connector tightening mechanism 110. As best seen in FIGS. 2 through 4, a plurality of connectors 206 connect upper fixture mount 106 to lower fixture mount 106. Connectors 206 may be cables, cables made of a corrosion resistant material, such as, for example, stainless steel, plastic or a composite material. Connectors 206 may be threaded rods, ribbons, thin bands, or the like. Connectors 206 may have a round cross-sectional shape, a rectangular cross-sectionals shape, or any other cross-sectional shape desirable for a particular purpose. In some embodiments, stainless steel cables are used. Cables are very strong and take up very little of the room in the hole 204 through the counter top 102.

Connector tightening mechanism 110 tightens the connectors 206 to secure upper fixture mount 104 and lower fixture mount 106 to the counter top 102. In one embodiment, connector tightening mechanism 110 is a ratchet style connector tightening mechanism 110. Connectors 206 are secure to lower fixture mount 106 at points 218 and to connector tightening mechanism 110 at connection points 210 (only one connection point is shown) which are stationary. Connectors 206 pass through apertures 410 in connector tightening mechanism 110. As connector tightening mechanism 110 is rotated, the connectors 206 coil up inside of connector tightening mechanism 110 and are shortened. Thus, the lower fixture mount 106 moves upward and contacts the bottom of counter top 102 to secure the fixture mounting system 100.

Connector tightening mechanism 110 includes ratchet teeth (not shown) and upper fixture housing 104 contains opposing projections (not shown) which engage the teeth as they rotate past. Thus, connector tightening mechanism 110 can only rotate in one direction and that direction tightens connectors 206. Optionally, a release mechanism (not shown) may be included so the fixture mounting system 100 may be removed from counter top 102.

In some embodiments, connector tightening mechanism 110 includes ribs 160. Ribs 160 provide a grip for a user to hand tighten connector tightening mechanism 110. Accordingly, in some embodiments, fixture mounting system 100 may be installed quickly without tools.

Other connector tightening mechanisms 110 may be used. In some embodiments, connectors 206 contain teeth (not shown) and connector tightening mechanism 110 contains pawls (not shown). As the connector 206 is pulled past the pawls, the teeth prevent the connector 206 from pulling back the other way. In some embodiments, connectors 206 are threaded and the ends in lower fixture mount 106 are retained so that they can rotate. The upper portion of threaded connector 206 may be turned. Upper fixture mount 106 contains a threaded engagement portion so that when the threaded connector 206 is rotated, upper fixture mount 106 moves downward tightening the fixture mounting system to the counter top 102.

FIG. 6 illustrates an exemplary system 600 having an above counter fixture 602 mounted to the upper fixture mount (not shown) on counter 102. FIG. 6 also illustrates lower fixture mount 106 unconnected. In some embodiments, fixture 602 may include, for example, a threaded pipe for connecting to a water supply that would extend below lower fixture mount 106.

Fixture 602 is a generic fixture. Above counter mount fixtures may include, for example, faucets, faucet spouts, faucet valves, faucet valve housings; soap dispensers, instant hot water dispensers, water purifier dispensers, and the like.

FIGS. 7 and 8 illustrate and exemplary system 700 having an above counter mount fixture 602 and a below counter mount fixture 702. Below counter mount fixture 702 is a generic fixture and may be any below counter mount fixture, such as, for example, the under counter portions of: faucets, faucet valve housings, soap dispensers, instant hot water dispensers, water purifier dispensers, refill units for soap or sanitizer dispenser, and the like

In the embodiment disclosed herein, the under counter fixture 702 has a mating connector 704 with elongated teeth 802 on each side that mates with the elongated slots 140 of lower fixture mount 104. In some embodiments, the elongated teeth 802 are on a clip 708 with a hinge 710 which is spring loaded so a user need only push the lower fixture 708 upward and the teeth contact the sloped portion 142 of lower fixture unit 106 and the clip 708 spreads open and the teeth 802 slide into the elongated grooves 140. The clip 708 then closes and secures the under counter fixture to the lower fixture mount 106. To remove the fixture a user need only push on clips 708.

Other types of connectors may be used, such as, for example, threads, pins and sockets, notches and “L” shaped grooves, and the like. A quick disconnect connector is particularly useful for under counter mount fixtures such as, for example, a soap or sanitizer refill unit. The lower fixture mount may be made of a plastic material, a composite material, a metal material and the like.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants' general inventive concept.

We claim:

1. A fixture mounting system comprising:
an upper fixture mount;
a lower fixture mount;
a plurality of connectors extending between the upper fixture mount and the lower fixture mount;
the lower fixture mount having a first portion and a second portion;
the first portion and the second portion connected together by a hinge;
wherein the first portion and the second portion may be folded together and inserted through a hole in a countertop and the first and second portion unfold upon passing through the countertop; and
the plurality of cables are tightened to secure the upper fixture mount and the lower fixture mount to the counter.

2. The fixture mounting system of claim 1 wherein the connectors comprise cables.

3. The fixture mounting system of claim 2 wherein the upper fixture mount comprises a ratcheting mechanism and the plurality of cables are connected to the ratcheting mechanism and the ratcheting system tightens the plurality of cables to secure the upper fixture mount and the lower fixture mount to the counter top.

4. The fixture mounting system of claim 2 wherein the ratcheting mechanism has a hand grip for hand tightening the ratcheting mechanism.

5. The fixture mounting system of claim 2 wherein the ratcheting mechanism causes the plurality of cables wind up in the upper housing.

6. The fixture mounting system of claim 1 wherein the upper fixture mount comprises a connector for connecting an above the counter fixture to the upper fixture mount.

7. The fixture mounting system of claim 6 further comprising an above the counter fixture.

8. The fixture mounting system of claim 7 wherein the above the counter fixture comprises at least a portion of a faucet, a soap dispenser, a hot water dispenser or a plumbing fixture.

9. The fixture mounting system of claim 1 wherein the lower fixture mount comprises a connector for connecting an under counter fixture to the lower fixture mount.

10. The fixture mounting system of claim 9 further comprising an under counter fixture.

11. The fixture mounting system of claim 10 wherein the under counter fixture comprises at least a portion of a soap dispenser, a hot water dispenser or a plumbing fixture.

12. The fixture mounting system of claim 1 further comprising an adhesive secured to the upper fixture mount.

13. The fixture mounting system of claim 1 further comprising a gasket that is placed between a counter top and the upper fixture.

14. A fixture mounting system comprising:
an upper fixture mount;
a lower fixture mount;
a plurality of connectors extending between the upper fixture mount and the lower fixture mount;
a connector tightening mechanism;
the lower fixture mount having a first portion and a second portion;
wherein the first portion and the second portion may be folded together and inserted through a hole in a countertop and the first and second portion unfold upon passing through the countertop; and
the plurality of cables are tightened to secure the upper fixture mount and the lower fixture mount to the counter.

15. The fixture mounting system of claim 14 wherein the connectors are cables.

16. The fixture mounting system of claim 15 wherein the upper fixture mount comprises a ratcheting mechanism and the plurality of cables are connected to the ratcheting mechanism and the ratcheting system tightens the plurality of cables to secure the upper fixture mount and the lower fixture mount to the counter top.

17. The fixture mounting system of claim 14 wherein the upper fixture mount comprises a connector for connecting an above the counter fixture to the upper fixture mount.

18. The fixture mounting system of claim 17 further comprising an above the counter fixture.

19. The fixture mounting system of claim 14 wherein the lower fixture mount comprises a connector for connecting an under counter fixture to the lower fixture mount.

20. The fixture mounting system of claim 19 further comprising an under counter fixture.

21. A fixture mounting system comprising:
an upper fixture mount;
a lower fixture mount;
a plurality of connectors extending between the upper fixture mount and the second fixture mount;
a connector tightening mechanism;
the lower fixture mount having a first portion and a second portion;
wherein the first portion and the second portion may be folded together and inserted through a hole in a countertop and the first and second portion unfold upon passing through the countertop; and
the plurality of connectors are tightened to secure the upper fixture mount and the lower fixture mount to the counter.

22. The fixture mounting system of claim 21 wherein the connector tightening mechanism comprises a ratcheting mechanism.

23. The fixture mounting system of claim 21 wherein the connector tightening mechanism comprises a threaded portion.

24. The fixture mounting system of claim 21 wherein the connector tightening mechanism comprises a teeth and pawl connection.

25. The fixture mounting system of claim 21 wherein the connectors are cables.

26. The fixture mounting system of claim 25 wherein the cables are round.

27. The fixture mounting system of claim 25 wherein the cables are corrosion resistant.

28. The fixture mounting system of claim 25 wherein the cables have a rectangular cross-section.
